(19) United States
(12) Patent Application Publication
(10) Pub. No.: US 2007/0086530 A1
(43) Pub. Date: Apr. 19, 2007

(54) Circuit arrangement for connecting a first circuit node to a second circuit node and for protecting the first circuit node for overvoltage

(75) Inventors: Derek Bernardon, Villach (AT); Dieter Haerle, Villach (AT)

Correspondence Address: Maginot, Moore & Beck;Suite 3250, Chase Tower, 111 Monument Circle, Indianapolis, IN, 46204, US

(73) Assignee: Infineon Technologies AG, Munich (DE)

(21) Appl. No.: 11/455,224

(22) Filed: Jun. 16, 2006

(30) Foreign Application Priority Data
Jun. 17, 2005 (DE) 102005028211.3-34

(51) Int. Cl. H04L 25/00

(52) U.S. Cl. 375/257

(57) ABSTRACT

A circuit arrangement connects a first node to a second node. The circuit arrangement includes a first semiconductor switching element and a drive circuit. The first semiconductor switching element has a load path and a control terminal, the load path being connected between the first and second nodes. The drive circuit operably coupled to the control terminal, and is configured to detect a first voltage applied to the first node. The drive circuit is further operable to regulate the first semiconductor switching element via its control input if the first voltage reaches a first threshold value.

### FIELD OF THE INVENTION

The invention relates to a circuit arrangement for connecting a first circuit node to a second circuit node and for protecting the first circuit node from overvoltage at the second circuit node.

### BACKGROUND

In many circuit applications, there is a need to protect one portion of a circuit from overvoltages present in another portion of the circuit. Such overvoltages can result in increased component damage or even safety concerns.

It is possible to provide at least some protection by employing a series resistance between nodes of a circuit to protect one node from an overvoltage present at another node. However, such protection relies on an undesirably high and permanent electrical resistance between the nodes.

### SUMMARY

At least some embodiments of the present invention address the above stated need by providing a circuit arrangement which makes it possible to connect the first circuit node to the second circuit node, with low electrical resistance between the first and second circuit nodes, and, in addition, provides the first circuit node with reliable protection from overvoltage. Still other embodiments of the invention address other needs.

A first embodiment of the invention is a circuit arrangement that connects a first node to a second node. The circuit arrangement includes a first semiconductor switching element and a drive circuit. The first semiconductor switching element has a load path and a control terminal, the load path being connected between the first and second nodes. The drive circuit operably coupled to the control terminal, and is configured to detect a first voltage applied to the first node. The drive circuit is further operable to regulate the first semiconductor switching element via its control input if the first voltage reaches a first threshold value.

In a further embodiment of the invention, the drive circuit comprises a voltage measuring arrangement which is connected to the first circuit node and provides a measurement voltage, a reference voltage source which provides a reference voltage, and a differential amplifier having a first input, a second input and an output, the measurement voltage being supplied to the first input of said amplifier, the reference voltage being supplied to the second input of said amplifier and the control input of the first semiconductor switching element being connected to the output of said amplifier.

Some embodiments of the circuit arrangement include a first overvoltage protection arrangement which protects the first semiconductor switching element from overvoltage at the control input of the latter. This overvoltage protection arrangement has, for example, a first zener diode which is reverse-biased between the control terminal and the first circuit node.

Irrespective of the presence of the first overvoltage protection arrangement, the circuit arrangement may have a second overvoltage protection arrangement which is connected to the first circuit node and is designed to drive the semiconductor switching element into the off state if the voltage at the first circuit node exceeds a second threshold value. In this case, this second threshold value is greater than the first threshold value at which the drive circuit responds in order to regulate the semiconductor switching element. In addition, the second overvoltage protection arrangement is designed to react to changes in the voltage at the first circuit node in a more rapid manner than the drive circuit. While the drive circuit of the first semiconductor switching element thus reacts to slow changes in the voltages at the first circuit node in order to limit the voltage at this node to the first threshold value, the second overvoltage protection arrangement is used, for example, to protect the first circuit node from rapid voltage pulses, for example those voltage pulses which are caused by ESD (Electro Statical Discharge) pulses.

In addition or as an alternative to the first and second overvoltage protection arrangements, provision may also be made of a third overvoltage protection arrangement which monitors the voltage at the second circuit node and drives the first semiconductor switching element into the off state if this voltage at the second circuit node is above a third threshold value. In this case, the task of the third overvoltage protection arrangement is to prevent overloading of the first semiconductor switching element, which would arise if, in the case of an excessively high voltage at the second circuit node over a long period of time, a high power loss were produced when regulating the voltage at the first circuit node.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a first exemplary embodiment of an inventive circuit arrangement having a first semiconductor switching element, which is connected between a first circuit node and a second circuit node, and a drive circuit for this first semiconductor switching element.

FIG. 2 shows an exemplary embodiment of the inventive circuit arrangement which additionally has a zener diode as an overvoltage protection arrangement at the control terminal of the first semiconductor switching element.

FIG. 3 shows another exemplary embodiment of an inventive circuit arrangement in which an additional overvoltage protection arrangement is connected between the first circuit node and a reference ground potential and drives the first semiconductor switching element.

FIG. 4 shows another exemplary embodiment of an inventive circuit arrangement which also has an overvoltage protection arrangement which monitors the voltage at the second circuit node.

FIG. 5 illustrates one possible intended use of the inventive circuit arrangement for protecting an output terminal of an operational amplifier.

### DETAILED DESCRIPTION

In the figures, unless specified otherwise, identical reference symbols denote identical circuit components with the same meaning.

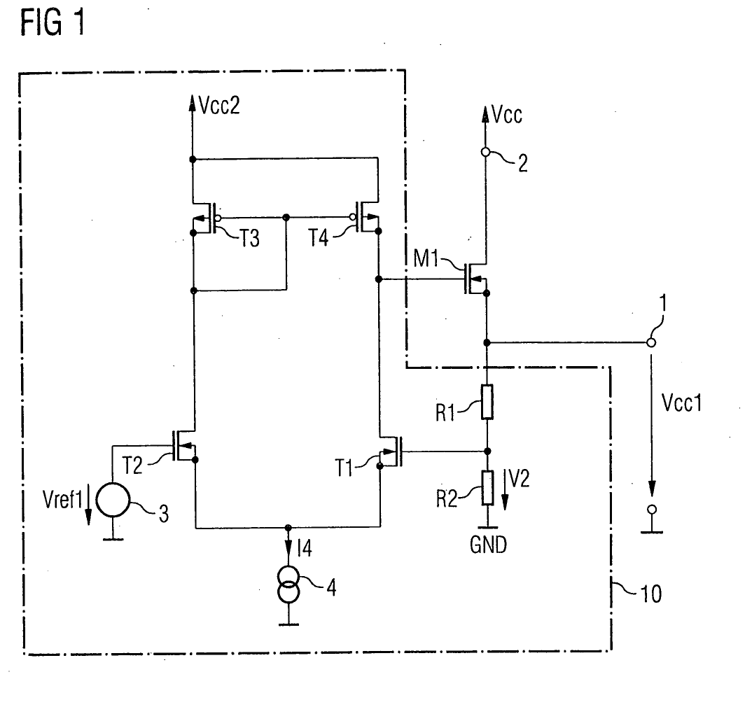

FIG. 1 shows an exemplary embodiment of an inventive circuit arrangement which is designed to electrically connect a first circuit node 1 to a second circuit node 2 and, in addition, to protect the first circuit node 1 from overvoltage. This circuit arrangement has a first semiconductor switching element M1 having a load path and a control terminal. The load path of this first semiconductor switching element M1 is connected between the first and second circuit nodes 1, 2 and the control terminal of this first semiconductor switching element M1 is driven by a drive circuit 10. In the exemplary embodiment illustrated, the first semiconductor switching element M1 is in the form of an n-channel MOSFET. In this case, the drain-source path of this MOSFET forms the load path and the gate connection of the MOSFET forms the control terminal.

The drive circuit 10 has a current measuring arrangement which, in the example, is in the form of a voltage divider having two resistors R1, R2 which are connected in series. In this case, the series circuit comprising these two resistors is connected between the first circuit node 1 and a reference ground potential GND. This voltage divider arrangement provides a measurement voltage V2 which corresponds to the voltage across that resistor R2 of the series circuit which is connected to reference ground potential.

An evaluation circuit compares this measurement voltage V2 with a reference voltage Vref1 provided by a reference voltage source 3 and drives the first semiconductor switching element M1 on the basis of this comparison result. In the example shown in FIG. 1, the evaluation circuit is in the form of a differential amplifier which has a first input transistor T1 and a second input transistor T2. In this case, the control terminal of the first input transistor T1 is connected to the node that is common to the voltage divider resistors R1, R2 and is thus driven by the measurement voltage V2. The second input transistor T2 is driven by the reference voltage Vref1. A current source 4 which generates a load current I4 is provided as a common load for the two input transistors T1, T2. The differential amplifier also has a current mirror T3, T4 having an input transistor T3, which is connected as a diode, and an output transistor T4. In this case, the input transistor T3 of the current mirror is connected between a drive potential Vcc2 and the second input transistor T2, while the output transistor T4 of the current mirror is connected between the drive potential Vcc2 and the first input transistor T1. The control terminal of the first semiconductor switching element M1 is connected in this case to a node that is common to the output transistor T4 of the current mirror and the first input transistor T1.

The functioning of the circuit illustrated in FIG. 1 will be explained below:

In a first example, it shall be assumed that the measurement voltage V2 is less than the first reference voltage Vref1. In this case, the second input transistor T2 of the differential amplifier is turned on to a greater degree than the first input transistor T1, with the result that the load current I4 almost completely flows through the second input transistor T2. This current which flows through the second input transistor T2 is mapped, via the current mirror T3, T4, to the control terminal of the first semiconductor switching element M1 in order to drive the first semiconductor switching element M1 into the on state or in order to connect the control terminal of the first semiconductor switching element M1 to the drive potential Vcc2. In this operating state, the first semiconductor switching element has been driven into the completely on state, with the result that the first semiconductor switching element M1 assumes a minimum input resistance. In this operating state, the MOSFET M1 acts as a switch and the connection between the first and second circuit nodes 1, 2 corresponds approximately to a short circuit.

If the measurement voltage V2 reaches or exceeds the first reference value Vref1, the first input transistor is turned on, with the result that the drive voltage of the first semiconductor switching element M1 is reduced in order to regulate the first semiconductor switching element M1 in such a manner that the first voltage Vcc1 at the first circuit node is limited to a value which is proportional, via the divider ratio of the voltage divider, to the reference voltage. The first threshold value of the voltage Vcc1 at the first circuit node 1, from which the first semiconductor switching element M1 is regulated, can be set using the measurement voltage V2 and the first reference voltage value Vref1. If the two voltage divider resistors R1, R2 have the same resistance values and if the first voltage is to be regulated to 5 V, for example, and if the second voltage exceeds this value of 5 V, then the reference voltage source 3 is selected in such a manner that it provides a first reference voltage Vref1 of 2.5 V.

In the operating state explained above, the drive circuit and the first semiconductor switching element M1 act as a voltage regulator which regulates the first voltage at the first circuit node 1 and limits it to an upper value. A voltage difference between the voltage Vcc that is applied to the second node 2 and the regulated first voltage is across the load path of the first semiconductor switching element M1 and is converted there into a power loss in the form of heat.

The circuit arrangement illustrated in FIG. 1 makes it possible to reliably set a maximum permissible voltage value of the first voltage Vcc1 and reliably protects the first circuit node 1 from overvoltages at the second circuit node 2. The first semiconductor switching element M1 is, for example, a power transistor which, depending on the embodiment, is suitable for reliably blocking voltages of several 10 V to several 100 V.

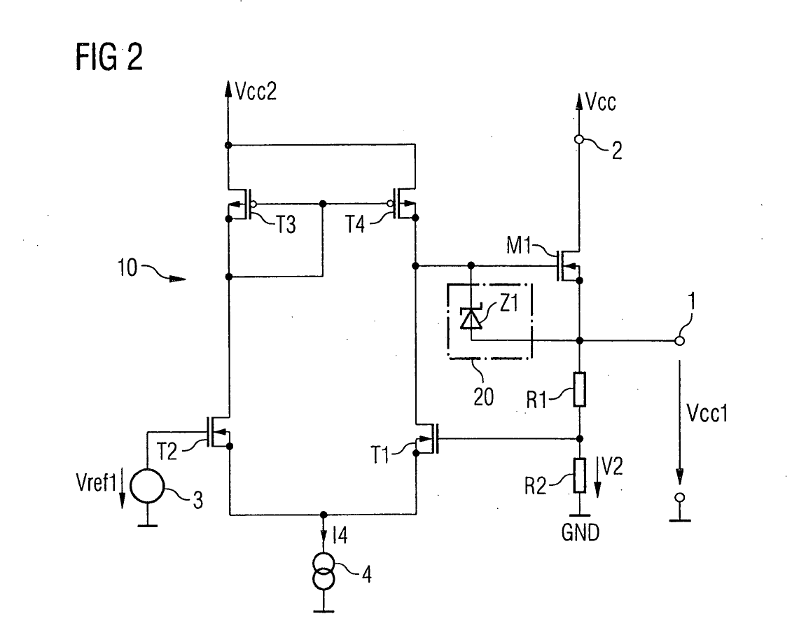

FIG. 2 shows an exemplary embodiment of the inventive circuit arrangement in which provision is additionally made of a first overvoltage protection arrangement 20 which protects the first semiconductor switching element M1 from overvoltage at the control terminal of the latter. This first overvoltage protection arrangement 20 has a zener diode Z1 which is reverse-biased between the control terminal and the first circuit node 1. In the case of an overvoltage of the drive potential Vcc2, this zener diode Z1 limits the drive voltage, i.e. the gate-source voltage, of the first semiconductor switching element M1 to the value of the breakdown voltage, for example 6.46 V, of the zener diode Z1.

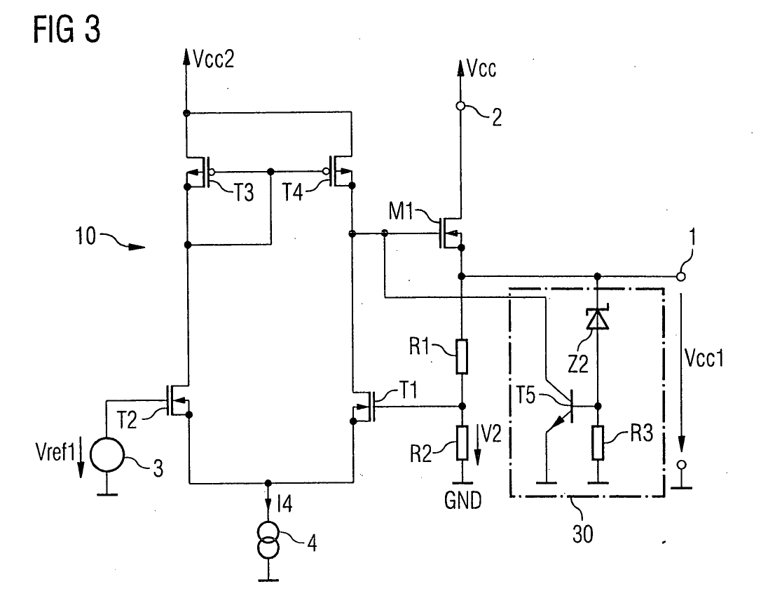

FIG. 3 shows an exemplary embodiment of an inventive circuit arrangement which contains a second embodiment of an overvoltage protection arrangement 30 which is designed to protect the first circuit node 1 from, in particular, rapidly rising voltage pulses, for example those voltage pulses which are caused by ESD pulses at the second circuit node 2. This second embodiment of an overvoltage protection arrangement 30 has a series circuit comprising a second zener diode Z2 and a further resistance element R3, said series circuit being connected between the first circuit node 1 and reference ground potential GND. The second overvoltage protection arrangement 30 also has a transistor element T5 which is in the form of a bipolar transistor, the load path (collector-emitter path) of which is connected between the control terminal of the first semiconductor switching element M1 and reference ground potential GND and the control terminal (base connection) of which is connected to the node that is common to the second zener diode Z2 and the resistance element R3. In this circuit arrangement, if the first voltage Vcc1 exceeds a voltage value that corresponds to the sum of the breakdown voltage of the zener diode Z2 and the threshold voltage of the bipolar transistor T5, the bipolar transistor T5 is driven into the on state in order to disable the first semiconductor switching element M1 until the voltage pulse has decayed.

On account of the fact that the second overvoltage protection arrangement 30 is partially implemented using bipolar technology, the overvoltage protection arrangement 30 reacts to changes in the voltage at the first circuit node 1 in a more rapid manner than the drive circuit 10 which is implemented using CMOS technology, for example. The second overvoltage protection arrangement 30 is therefore suitable for protecting the first circuit node 1 from rapid voltage rises, for example voltage rises caused by ESD pulses, while the drive circuit 10 protects the circuit node 1 from voltages which rise more slowly at the second circuit node 2. In addition, the drive circuit 10 ensures that the first semiconductor switching element M1 is driven into the on state if the first voltage Vcc1 at the first circuit node 1 is less than the threshold value of this first voltage Vcc1, said threshold value being set using the voltage divider R1, R2 and the reference voltage Vref1.

Since the drive circuit 10 reacts more slowly than the second overvoltage protection arrangement 30, the first voltage Vcc1 may rise above the preset first limiting value in the case of rapid voltage changes at the second circuit node 2. If this voltage Vcc2 reaches the limiting value which has been set using the breakdown voltage of the second zener diode Z2 and the threshold voltage of the transistor T5, the first semiconductor switching element M1 is driven into the off state. The rapid reaction time of the second voltage protection arrangement 30 ensures that the first voltage Vcc1 exceeds that limiting value which has been set using the voltage divider R1, R2 and the first reference voltage source 3 for a very short period of time, if necessary.

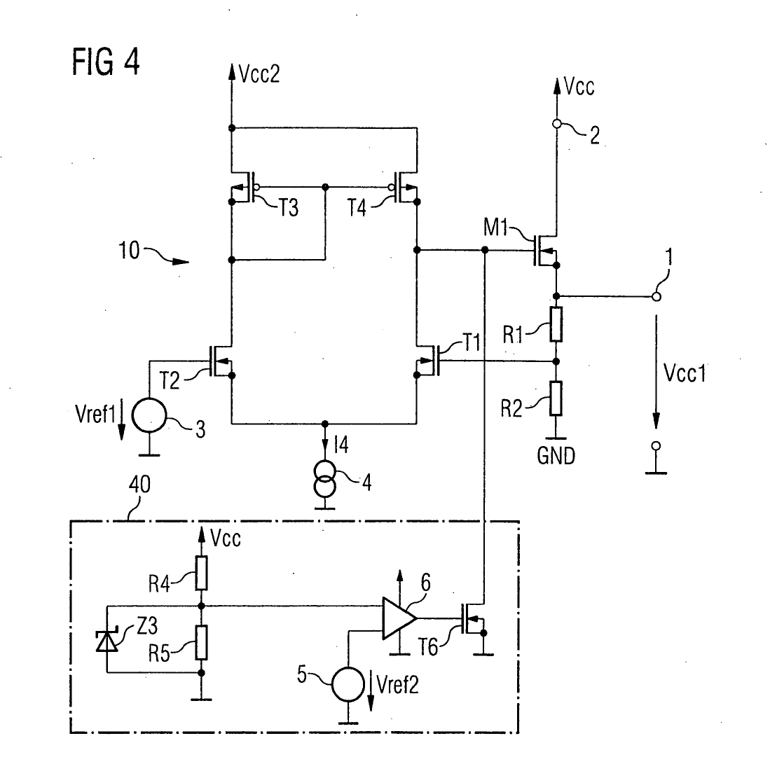

As already explained, in the case of a voltage Vcc at the second circuit node 2 which is higher than the first threshold value of the first voltage Vcc1, the drive circuit 10 drives the first semiconductor switching element M1 in such a manner that a voltage drop across this first semiconductor switching element M1 corresponds to the difference between the voltage Vcc at the second circuit node 2 and the first threshold value of the first voltage Vcc1. The power loss produced during this regulating operating state in the first semiconductor switching element M1 results in the first semiconductor switching element M1 being heated. In order to prevent this first semiconductor switching element M1 from being overheated, the exemplary embodiment of the circuit arrangement illustrated in FIG. 4 provides a further overvoltage protection arrangement 40 which detects the voltage Vcc at the second circuit node 2 and drives the first semiconductor switching element M1 into the off state, via a further transistor element T6, if this voltage Vcc exceeds a further limiting value. In this protection arrangement 40, the transistor element T6 is connected between the control terminal of the first semiconductor switching element M1 and reference ground potential GND. This transistor element T6 is driven via a comparator 6 which compares a measurement signal V5 derived from the voltage Vcc across a voltage divider R4, R5 with a second reference value Vref2. The comparator arrangement 6 which is in the form of a comparator, for example, drives the transistor element T6 into the on state in this case if the measurement voltage V5 is greater than the second reference voltage Vref2. A third zener diode Z3 which is connected in parallel with the inputs of the comparator 6 protects the comparator 6 from overvoltage at the input of the latter.

The protection arrangement 40 thus drives the first semiconductor switching element M1 into the off state if the voltage Vcc at the second circuit node 2 assumes a voltage value at which overheating of the first semiconductor switching element M1 is to be feared during long-term operation. The limiting value of the second voltage Vcc, at which the first semiconductor switching element M1 is disabled via the protection arrangement 40, is 8.5 V, for example.

In a manner not described in any more detail, it is also possible to use a temperature sensor to detect a temperature in the region of the first semiconductor switching element and to drive the transistor element T6 on the basis of a temperature signal generated by the sensor. The first semiconductor switching element is thus directly protected from overheating.

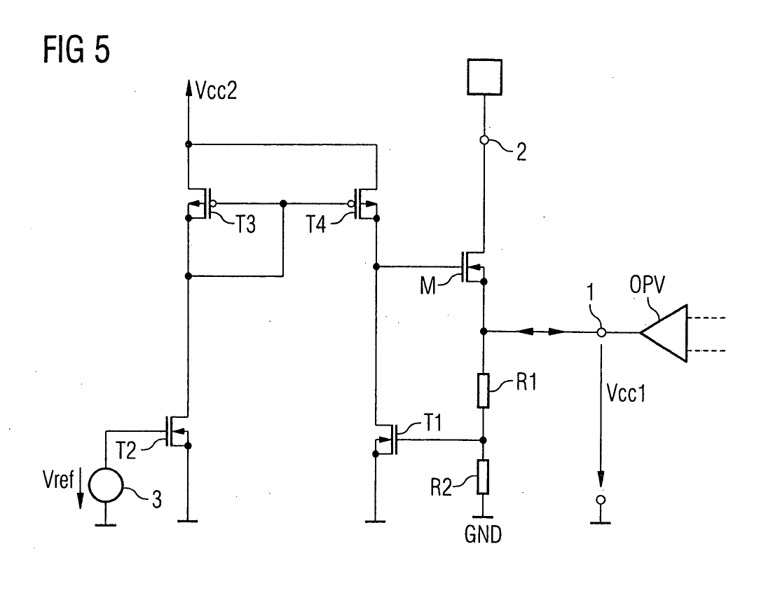

The circuit arrangement explained above may be used, with reference to FIG. 5, as a protective circuit for the output of an operational amplifier OPV, in particular. In this case, the first circuit node 1 corresponds to the output of the operational amplifier OPV. The second circuit node 2 corresponds to a connection pin, to which or from which current may flow in the direction of the output of the operational amplifier OPV.

1. A circuit arrangement for connecting a first node to a second node, said circuit arrangement comprising:
a first semiconductor switching element having a load path and a control terminal, the load path being connected between the first and second nodes,
a drive circuit operably coupled to the control terminal, the drive circuit configured to detect a first voltage applied to the first node and to regulate the first semiconductor switching element via its control input if the first voltage reaches a first threshold value.

2. The circuit arrangement as claimed in claim 1, wherein the drive circuit is further configured to drive the first semiconductor switching element into a substantially completely on state if the first voltage is less than the first threshold value.

3. The circuit arrangement as claimed in claim 1, wherein the drive circuit further comprises:
a voltage measuring arrangement connected to the first node and configured to and providing a measurement voltage, and
a differential amplifier having a first input, a second input and an output, the first input operably coupled to receive the measurement voltage, the second input operably coupled to receive a reference voltage, and the output operably coupled to the control terminal.

4. The circuit arrangement as claimed claim 1, further comprising an overvoltage protection arrangement connected between the control terminal of the first semiconductor switching element and the first node.

5. The circuit arrangement as claimed in claim 4, wherein the overvoltage protection arrangement includes a first zener diode which is reverse-biased between the control terminal and the first node.

6. The circuit arrangement as claimed in claim 4, wherein the overvoltage protection arrangement is configured to drive the semiconductor switching element into the off state if the voltage at the first node exceeds a second threshold value.

7. The circuit arrangement as claimed in claim 6, wherein the first threshold value is less than the second threshold value and wherein the overvoltage protection arrangement is configured to react to changes in the voltage at the first node in a more rapid manner than the drive circuit.

8. The circuit arrangement as claimed in claim 6, wherein the overvoltage protection arrangement comprises:
a series circuit being connected between the first node and a reference ground potential, the series circuit comprising a zener diode and a resistance element,
a second transistor element having a load path and a control terminal, the second transistor load path connected between the control terminal of the first transistor element and the reference ground potential, and the second transistor control terminal connected to a node that is common to the zener diode and the resistance element.

9. The circuit arrangement as claimed in claim 6, further comprising a second overvoltage protection arrangement configured to drive the first semiconductor switching element into the off state if a voltage at the second node is above a third threshold value.

10. The circuit arrangement as claimed in claim 9, wherein the second overvoltage protection arrangement comprises:
a second transistor element having a load path and a control terminal, the second transistor load path connected between the control terminal of the first transistor element and the reference ground potential; and
a comparator arrangement configured to compare the voltage at the second node with the third reference value and to drive the second transistor element on the basis of this comparison result.

11. The circuit arrangement as claimed in claim 1, wherein the first node comprises an output terminal of an operational amplifier.

12. The circuit arrangement as claimed in claim 1, wherein the second node is a supply voltage node.

13. The circuit arrangement as claimed in claim 6, wherein the overvoltage protection arrangement comprises:
a second transistor element having a load path and a control terminal, the second transistor load path connected between the control terminal of the first transistor element and the reference ground potential; and
a comparator arrangement configured to compare the voltage at the second node with a second reference value and to drive the second transistor element on the basis of this comparison result.

14. A circuit arrangement for connecting a first node to a second node, said circuit arrangement comprising:
a first semiconductor switching element having a load path and a control terminal, the load path being connected between the first and second nodes; and
a drive circuit configured to drive the first semiconductor switching element into a substantially completely on state if the first voltage is less than the first threshold value, the drive circuit comprising
a voltage measuring arrangement connected to the first node and configured to and providing a measurement voltage, and
a differential amplifier having a first input, a second input and an output, the first input operably coupled to received the measurement voltage the measurement voltage, the second input operably coupled to receive a reference voltage, and the output operably coupled to the control terminal.

15. The circuit arrangement as claimed in claim 14, further comprising an overvoltage protection arrangement connected between the control terminal of the first semiconductor switching element and the first node.

16. The circuit arrangement as claimed in claim 15, wherein the overvoltage protection arrangement includes a first zener diode which is reverse-biased between the control terminal and the first node.

17. The circuit arrangement as claimed in claim 15, wherein the overvoltage protection arrangement is configured to drive the semiconductor switching element into the off state if the voltage at the first node exceeds a second threshold value.

18. The circuit arrangement as claimed in claim 17, wherein the first threshold value is less than the second threshold value and wherein the overvoltage protection arrangement is designed to react to changes in the voltage at the first node in a more rapid manner than the drive circuit.

19. A method, comprising:
providing a first semiconductor switching element having a load path and a control terminal, the load path being connected between a first node and a second node;
detecting a first voltage applied to the first node using a drive circuit operably coupled to the control terminal; and
regulating, if the first voltage reaches a first threshold value, the first semiconductor switching element via the control terminal using the drive circuit.

20. The method of claim 19, further comprising:
using the drive circuit to drive the semiconductor switching element into a substantially completely on state if the first voltage is less than the first threshold value using the drive circuit; and
driving the semiconductor switching element into the off state if the voltage at the first node exceeds a second threshold value.
